(19) United States
(12) Patent Application Publication
(10) Pub. No.: US 2013/0098295 A1
(43) Pub. Date: Apr. 25, 2013

(54) METHOD AND ARRANGEMENT FOR CONTROL OF THE MILKING

(71) Applicant: Ron Mulder, TeAroha (NZ)

(72) Inventor: Ron Mulder, TeAroha (NZ)

(73) Assignee: DELAVAL HOLDING AB, Tumba (SE)

(21) Appl. No.: 13/808,273

(22) PCT Filed: Jul. 5, 2011
(86) PCT No.: PCT/SE2011/050905

§ 371 Date: Jan. 4, 2013

Related U.S. Application Data
(60) Provisional application No. 61/362,383, filed on Jul. 8, 2010.

(30) Foreign Application Priority Data
Jul. 8, 2010 (SE) 1050759-8

(51) Int. Cl. A01J 5/00

(52) U.S. Cl. CPC A01J 5/007; A01J 5/00; A01J 5/003
USPC 119/14.02; 119/14.08; 119/14.04

(57) ABSTRACT

An arrangement for control of milking of animals permitted to move in an area that includes a milking area with an automatic milking system, the arrangement including at least one animal identification device for identifying the animals entering the milking area, and a process and control device operatively connected to the animal identification device. The process and control device determines, for each of the identified animals, an expected milk yield obtainable in milking that animal, determines repeatedly an accumulated expected milk yield obtainable in milking the identified animals based on the expected milk yields of the identified animals, and initiates a milking session depending on the repeatedly determined accumulated expected milk yield.

### TECHNICAL FIELD OF THE INVENTION

The present invention relates to a method and an arrangement for control of the milking of animals by an automatic milking system.

### DESCRIPTION OF RELATED ART AND BACKGROUND OF THE INVENTION

Automatic milking systems (AMS) are well known in the art. The current implementations of AMS are almost entirely with housed cows. Cows are bedded and fed in a large barn that also houses the AMS. Cows learn to circulate freely the short distance between their cubicles and the AMS unit, a prime motivator being in-bail feeding while they are being milked in the AMS. The cows only need to move comparatively short distances, perhaps 20-30 meters within the housing system to the AMS.

Many cows around the world are not housed in this fashion, however, but are allowed to freely graze on pastures. In Australia and New Zealand, in particular, there is no housing of cows; they spend all their time on pasture. These pasture-based systems are very extensive and often require the cows to walk considerable distances to be milked in conventional milking systems. This can be up to 2-3 km walking distance, and they normally do this twice a day. Voluntary milking systems, which cows visit on a voluntary basis, have become increasingly common during the last years. In such systems cows are monitored and are given milking permission on an individual basis.

AU 2009202368 A1 discloses a system for management of animals which are allowed to move in an area intended therefore, wherein the area includes at least one grazing paddock in which the animals can graze, a milking area in which the animals are milked, and a waiting area, wherein the milking area and the waiting area are each accessible from the at least one grazing paddock, and the milking area is accessible from the waiting area. Hereby, animals which are almost qualified for milking can be kept in the waiting area during a shorter period of time before being milked in the milking area. If these animals would be redirected to grazing paddocks far away or if they were never allowed to reach the surroundings of the milking area, the probability that the animals would soon again visit the milking area is low and as a result the milk production would be lower.

A rotary milking system comprises a rotary platform, which milking animals enter and leave in a sequential order in order to be milked. The rotary platform comprises a plurality of milking stalls, each provided with milking equipment for milking an animal present in the milking stall during rotation of the rotary platform. Recently, such rotary milking system has been automated, wherein teat cups of the milking equipments are automatically attached to the teats of the animals to be milked by a robot arm provided with a gripper, see e.g. WO 2009/093964. One or two robot arms may serve all or at least several milking stalls of the automated rotary milking system.

### SUMMARY OF THE INVENTION

The implementation of automated rotary milking systems for voluntary milking is not straightforward. The rotary milking system was originally developed for batch milking of animals, and requires typically a large number of animals to be milked concurrently with one another.

Particularly, during times of low traffic of animals to the milking area, the automated rotary milking system for voluntary milking seems to be an inefficient solution if no further measures are taken to improve efficiency. This holds true for areas with freely grazing animals as well as for indoor arrangements.

While AU 2009202368 A1 discloses an automatic milking system for freely grazing animals that indeed will increase the throughput of animals through the milking system and thus increase milk production, there are many more measures to be taken in order to optimize productivity, in particular if rotary milking systems are to be used for voluntary or semi-voluntary milking of animals.

Similar limitations and drawbacks would be obtained in other types of milking systems arranged for voluntary or semi-voluntary milking of animals, particularly in those wherein a plurality of animals are milked concurrently with one another.

There is thus an object of the invention to provide a method and an arrangement for control of the milking of animals in an automatic milking system arranged for milking of animals, which provide for improved efficiency of the milking production and thereby increased revenues.

It is a further object of the invention to provide such method and arrangement, which are robust, effective, fast, precise, accurate, reliable, safe, easy to use, and of reasonable cost.

These objects, among others, are according to the present invention attained by methods and arrangements as specified in the appended patent claims.

According to a first aspect of the invention, a method is provided for control of the milking of animals which are allowed to move in an area intended therefore, wherein the area includes a milking area, wherein the milking area comprises an automatic milking system for milking the animals which have entered the milking area in a milking session. According to the method, each of the animals entering the milking area is identified, and, for each of the identified animals, an expected milk yield obtainable in milking that animal is determined. As the animals enter the milking area, an accumulated expected milk yield obtainable in milking the identified animals is repeatedly determined based on the expected milk yields of the identified animals. The milking session by the automatic milking system is started depending on the repeatedly determined accumulated expected milk yield. The expected milk yields obtainable in milking the animals are, for each animal, preferably determined based on previously collected data regarding that animal, wherein the data includes any of previous milk yields, previous milking times, and previous times lapsed between milkings of that animal.

Preferably, the automatic milking system is an automatic milking system wherein a plurality of the animals are milked concurrently with one another, such as e.g. an automated rotary milking system.

In one embodiment, the milking session by the automatic milking system is initiated when the repeatedly determined accumulated expected milk yield raises above a threshold value, which is based on the revenues of the repeatedly determined accumulated expected milk yield and the costs for operating the automatic milking system. Hereby, the milk production can be improved in terms of reduced operation costs. The costs for operating the system, e.g. in terms of operation costs per running minute, may be calculated in various manners known to a person skilled in the art. Obviously, it may vary considerably from one kind of milking system to another. It may also vary from farm to farm.

In another embodiment, animals that are to visit the milking area are identified at one or several places remotely located with respect to the milking area, expected times for travelling from the places where they were identified to the milking area are determined, future arrivals of identified animals to the milking area are predicted, and initiation of the milking session is made dependent also on the predicted future arrival of identified animals to the milking area.

Additionally, expected future milk yields are determined for the animals identified at one or several places remotely located with respect to the milking area, an accumulated future expected milk yield is determined based on the determined expected future milk yields, and the initiation of the milking session is made dependent also on the accumulated future expected milk yield. Hereby, an improved method is obtained which further improves milk production.

This method would be particularly suitable for animals on pasture, wherein the distances between the grazing paddocks and the milking area are long.

According to a second aspect of the invention, a control arrangement is provided by which the control method of the first aspect of the invention can be implemented. The arrangement comprises at least one animal identification device for the identifications, and a process and control device operatively connected to the animal identification device for performing the steps of determining the milk yields, repeatedly determining the accumulated milk yield, and initiating the milking session.

According to a third aspect of the invention, a computer program product is provided which is loadable into the internal memory of a computer of an animal handling arrangement and comprises software code portions for performing the control method of the first aspect of the invention when the computer program product is run on the computer.

Further characteristics of the invention, and advantages thereof, will be evident from the detailed description of embodiments of the present invention given hereinafter and the accompanying FIGS. 1-3, which are given by way of illustration only, and thus are not limitative of the present invention.

### BRIEF DESCRIPTION OF THE DRAWINGS

FIG. 1 illustrates schematically an arrangement for housing animals and a control arrangement in accordance with an embodiment of the invention implemented in the arrangement.

FIG. 2 illustrates schematically an enlarged portion of the arrangement of FIG. 1 and the control arrangement.

FIG. 3 is a flow scheme of a control method in accordance with an embodiment of the invention.

### DETAILED DESCRIPTION OF EMBODIMENTS

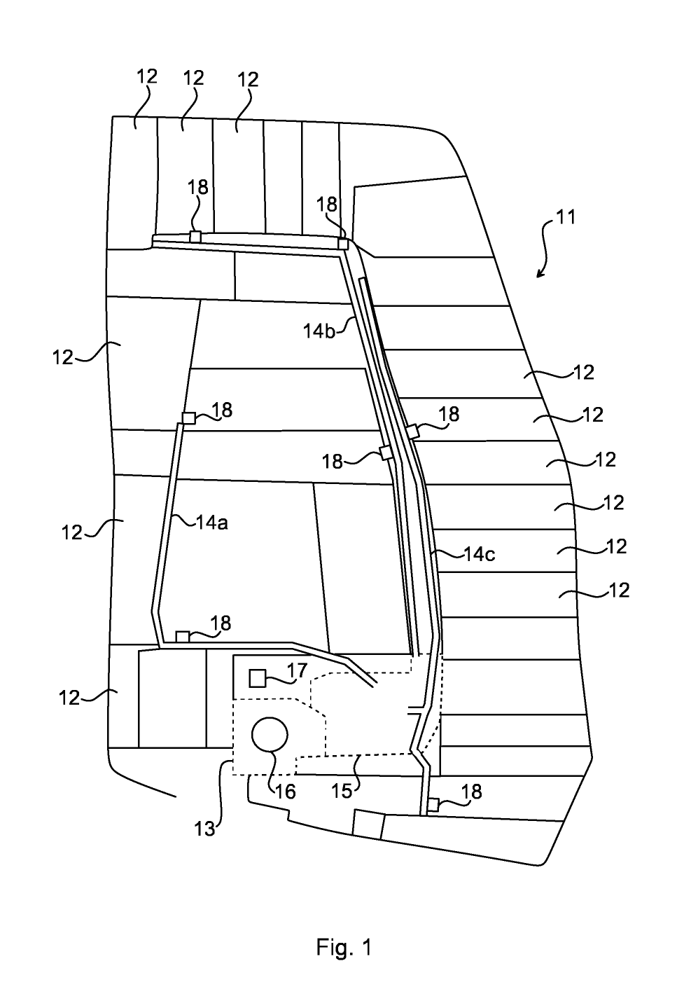

FIG. 1 illustrates schematically a pasture based animal arrangement for housing animals which are allowed to move in an area 11 thereof. The area 11 comprises preferably a large number of grazing pastures 12 in which the animals can graze, a milking area 13 located remote from the grazing paddocks 12, and various raceways 14a-c and a pre- and postmilking area 15, via which the animals in the grazing paddocks 12 can access the milking area 13 and vice versa. The milking area 13 comprises an automated rotary milking system 16 preferably for voluntary milking of the animals which have accessed the milking area 13 in a milking session. During such a milking session, animals in the milking area 13 may be pre-treated, milked, and post-treated by the automated rotary milking system 16. It is alternatively possible for pre- and/or post-treatment to take place in separate pre- and post-treatment devices present in the milking area 13.

The pasture based animal arrangement comprises further preferably a plurality of animal identification devices 18 arranged in the various raceways 14a-c at different distances from the milking area 13, each for identifying an animal passing that animal identification device 18.

In one embodiment, an animal identification device is arranged at the entry/exit of each of the grazing paddocks 12 to monitor the identities of the animals that enter and exit the grazing paddock 12. Each of the entries/exits may be provided with a gate arrangement operatively connected to the animal identification device arranged at that entry/exit for only allowing an animal to enter/exit that grazing paddock after having been identified, and optionally only in the event the identified animal fulfils some kind of criterion. Animals can thus be identified at the respective grazing paddock 12 before being allowed to enter the respective raceway 14a-c and again be identified when passing an animal identification device 18 in the respective raceway 14a-c.

A process and control device 17 is operatively connected to each animal identification device 18 for receiving identifications, optionally to each gate arrangement for the control thereof, and to the automated rotary milking system 16 for the control thereof.

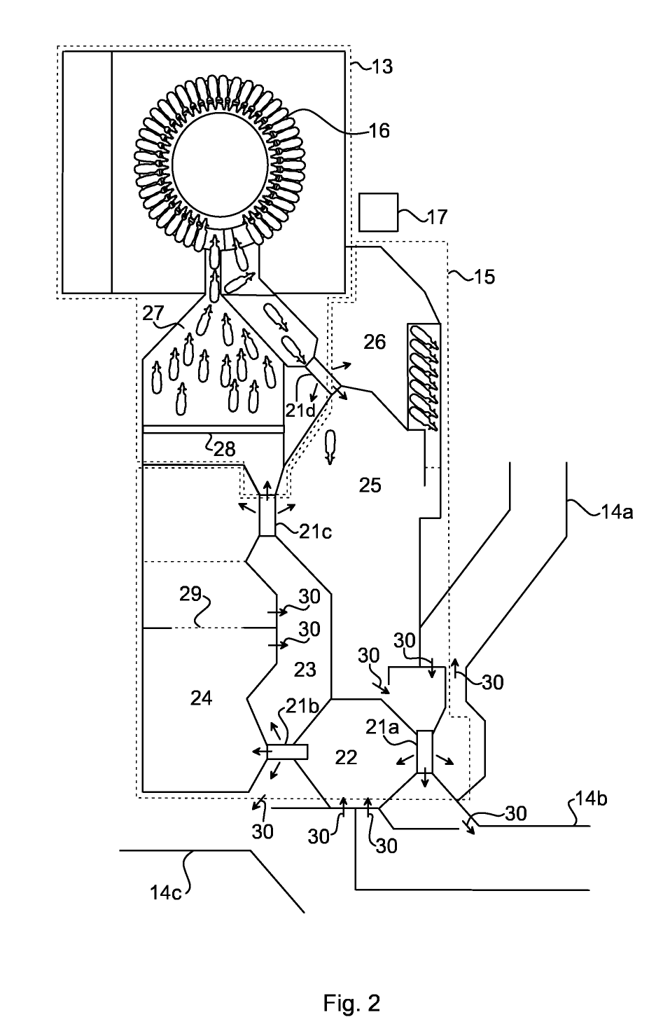

With reference next to FIG. 2, which illustrates schematically an enlarged portion of the area of FIG. 1, there is provided four selection boxes 21a-d, two 21a-b of which animals may have to pass to enter the pre- and postmilking area 15 from the various raceways 14a-c, one 21c of which animals have to pass to enter the milking area 13 from the pre- and postmilking area 15, and one 21d of which animals have to pass after having been milked by the automated rotary milking system 16. Each of the selection boxes 21a-d has one entry and is provided with an animal identification device for identification of the animal entering the selection box 21a-d and is operatively connected to the process and control device 17 for control. Each of the selection boxes 21a-d has three exits wherein each animal can be allowed, guided, or forced to exit either one of the three exits after having been identified and depending on one or several criteria. The pre- and postmilking area 15 comprises different enclosed areas 22-26, and the milking area 13 comprises a gathering area 27 and an automatic backing gate 28 operatively connected to the process and control device 17 for forcing animals in the gathering area 27 towards the automated rotary milking system 16.

An animal that walks the raceway 14 towards the pre- and postmilking area 15 reaches a first selection box 21a. The animal is identified, and depending on one or several criteria the animal is allowed to enter area 22, to enter raceway 14b, or to re-enter raceway 14a. In the two latter instances, the animal is guided back to a grazing paddock that can be accessed via any of raceways 14b, 14a. This may be desirable if the animal has no milking permission and should not be treated.

If the animal enters area 22, it then reaches a second selection box 21b. The animal is again identified, and depending on one or several criteria the animal is allowed to enter area 23, area 24, or raceway 14c. In the latter instance, the animal is guided back to a grazing paddock that can be accessed via raceway 14c. Area 24 is a waiting area or a treatment area, whereto the animal is guided if e.g. it is almost qualified for milking or if it is to be treated before milking. Area 24 may offer feed, water, and/or rest to the animal.

If the animal enters area 23, it then reaches a third selection box 21c. The animal is again identified, and depending on one or several criteria the animal is allowed to enter area 24, gathering area 27 of the milking area 13, or area 25. Area 24 may be divided into two separate portions by a wall, fence, or similar at 29, and thereby the animal can be guided to either portion by the second and third selection boxes 21b and 21c. Area 25 is a postmilking area 25 which may offer feed, water, and/or rest to the animal. The postmilking area 25 leads back to the first selection box 21a. By means of the first selection box 21a and optionally the second and/or third selection boxes 21b and 21c, the animal can be guided back to a grazing paddock via any of the raceways 14a-c or to any of the portions of the area 24.

If the animal is qualified for milking and should not wait for some reason, e.g. being treated, it is allowed to enter the gathering area 27 of the milking area 13 to be milked in the automated rotary milking system 16 in a milking session.

The automated rotary milking system 16 comprises in a conventional manner a rotary platform, which animals preferably enter and leave in a sequential order in order to be milked. The rotary platform comprises a plurality of milking stalls, each provided with milking equipment for milking an animal present in the milking stall. The rotary platform rotates with the milking stalls and the animals, which have entered the rotary platform, so that each animal has been entirely milked when the animal has been rotated almost one full revolution. In an automated rotary milking system the teat cups are automatically attached to the teats of the animals to be milked by a robot arm provided with a gripper, see e.g. WO 2009/093964, the contents of which being hereby incorporated by reference.

After milking, the animal enters the fourth selection box 21d. The animal is identified and depending on one or several criteria, the animal is allowed to enter postmilking area 25, the gathering area 27 of the milking area 13, or area 26. The animal may be guided back to the gathering area 27 of the milking area 13 if e.g. it was not appropriately milked for some reason. Area 26 is a further waiting area or a treatment area, and animals collected in this area may eventually be led to the postmilking area 25 and be guided to a grazing paddock or elsewhere. Area 26 may offer feed, water, and/or rest to the animal.

The traffic direction of animals in the pre- and postmilking area 15, in the milking area 13, and in the ends of the raceways 14a-c, is indicated by arrows 30. In order to obtain the illustrated traffic direction, a number of one-way gates may be provided, which can be opened by the animal, by an operator, or automatically under control of the process and control device 17. In particular, the gates that lead animals from the portions of area 24 back to area 23 may be provided with identification devices such that selected animals may be allowed to enter area 23 from area 24 after having been identified.

The present invention relates to an arrangement for control of the milking of animals by the automated rotary milking system 16. The arrangement comprises at least the animal identification device of the third selection box 21c and the process and control device 17. Each of the animals that enters the gathering area 27 of the milking area 13 is identified by the identification device of the third selection box 21c. The process and control device 17 is, for each of the identified animals, arranged to determine an expected milk yield obtainable in milking that animal. This determination may be based on previously collected data regarding that animal, wherein such data may include any of previous milk yields, previous milking times, and previous times lapsed between milkings of that animal.

Further, the process and control device 17 is arranged to repeatedly determine an accumulated expected milk yield obtainable in milking the animals in the gathering area 27 based on the expected milk yields of the identified animals. That is, for each animal entering the gathering area 27, its expected milk yield is added to the expected milk yield accumulated for those animals that are already present in the gathering area 27. It shall be appreciated that as time passes the expected milk yield may increase for each of the animals present in the gathering area 27. The process and control device 17 advantageously takes this into account when repeatedly determining the accumulated expected milk yield obtainable in milking the animals in the gathering area, such that the accumulated expected milk yield is repeatedly updated not only by the expected milk yields of new animals entering the gathering area 27 but also by updated expected milk yields of the animals already present in the gathering area 27.

Finally, the process and control device 17 is arranged to initiate a milking session by the automated rotary milking system 16 depending on the repeatedly determined accumulated expected milk yield. In particular, the milking session by the automated rotary milking system 16 may be initiated when the repeatedly determined accumulated expected milk yield raises above a threshold value, which threshold value is based on the revenues of the repeatedly determined accumulated expected milk yield and the costs for operating the automated rotary milking system 16.

The threshold value may also be based on a preparation time for the automated rotary milking system 16 comprising e.g. an expected time for moving the automatic backing gate 28 towards the automated rotary milking system 16 and/or an expected time for attaching teat cups to a first one of the animals to be milked.

It shall be appreciated that in some situations, e.g. if it is not healthy for an animal not to be milked (if the animal has waited for milking so long time that this presents a health risk) or if an animal urgently has to be guided to area 26, which can only be reached via the milking system 16, for some reason a milking session may be initiated in order to milk that animal irrespective of the accumulated expected milk yield, in order to maintain good animal health. Alternatively, an operator is alerted.

The initiation of the milking session may comprise to start moving the automatic backing gate 28 towards the automated rotary milking system 16, to start rotating the rotating platform of the automated rotary milking system, and/or to allow a first one of the animals to be milked to enter a milking stall of the rotating platform.

By means of the present invention it can be controlled exactly when a milking session by the automated rotary milking system should be initiated in order to achieve an optimum milk production in terms of produced milk versus its production costs.

This far an inventive arrangement has been disclosed which takes into account the animals in the gathering area and their expected milk yields. However, the decision to initiate a milking session could preferably be dependent also on an expected future milk yield of an expected future amount of animals in the gathering area 27.

A very simple approach, which does not require the use of additional identification devices, is simply to configure the process and control device 17 to register an entry time for each of the animals entering the gathering area 27 of the milking area 13, and to base the above disclosed threshold value also on the entry times. That is, by means of the frequency of entries to the gathering area, predictions on future entries may be made, by simple extrapolation, or by other mathematical processing of the entry data. The more frequent entries that are registered, the more animals are expected to enter the animal area in the near future, and vice versa. However, in this approach the identities of the animals to arrive are not known and thus their expected milk yields have to be determined based on median or mean values of milk yields for a group of animals.

A more sophisticated approach is to use at least one of the animal identification devices 18 which are located remote from the automated rotary milking system 16, preferably a plurality of them located at different distances from the milking area 13, and optionally the identification devices of selection boxes 21a and 21b. If a milking decision can be taken for an animal at an early stage, e.g. already at the grazing paddock 12 where it grazes or early in the raceway 14a-c that leads from the grazing paddock 12 to the milking area 13, it is possible to predict when the animal reaches the gathering area 27 of the milking area 13 based on historical data for that animal or for a group of animals. As the animal passes more identification devices closer to the gathering area 27 of the milking area 13, the predicted arrival time of the animal at the gathering area 27 can be modified; i.e. the closer the animal is to the gathering area 27, the more exact is the predicted arrival time.

The process and control device 17 is thus arranged to predict a future amount of animals in the gathering area 27 of the milking area 13 based on the animals identified by one or more of the animal identification devices 18 located remote from the automated rotary milking system 16 and optionally by the identification devices of selection boxes 21a and 21b. The process and control device 17 is further arranged to predict an expected future accumulated milk yield obtainable in milking the predicted identified future amount of animals based on their expected future milk yields. Finally, the process and control device 17 is arranged to initiate the milking session by the automated rotary milking system 16 also depending on the predicted identified future amount of animals in the milking area and optionally on the predicted future accumulated expected milk yield.

Hereby, not only the animals that actually are present in the gathering area 27 of the milking area 13 and their expected milk yields are taken into account in the decision on when to initiate the milking session, but also animals that are predicted to be in the gathering area 27 of the milking area 13 in the future and their expected future milk yields are taken into account.

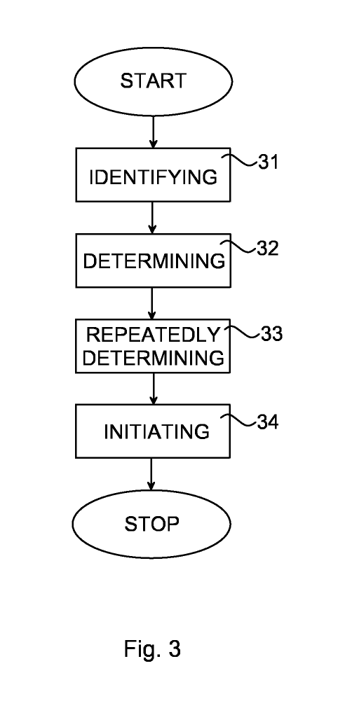

FIG. 3 is a flow scheme of a method for control of the milking of animals which are allowed to move in an area intended therefore, wherein the area includes at least one grazing paddock in which the animals can graze, a milking area located remote from the grazing paddock, and a raceway via which animals in the grazing paddock can enter the milking area, and wherein the milking area comprises an automated rotary milking system for milking the animals which have entered the milking area in a milking session, i.e. a method for control of the milking of animals in a milk handling system such as e.g. the milk handling system of FIG. 1.

According to the method, each of the animals entering the milking area is, in a step 31, identified. Next, for each of the identified animals, an expected milk yield obtainable in milking that animal is, in a step 32, determined, preferably repeatedly determined. As the animals enter the milking area, an accumulated expected milk yield obtainable in milking the animals in the milking area is, in a step 33, repeatedly determined based on the expected milk yields of the identified animals. Finally, the milking session by the automated rotary milking system is, in a step 34, initiated depending on the repeatedly determined accumulated expected milk yield. The determinations may be performed as disclosed above with reference to FIGS. 1-2. The milking session is preferably initiated when the revenues of the repeatedly determined accumulated expected milk yield increases above the costs for operating the automated rotary milking system.

The invention encompasses also an automated rotary milking system comprising any of the inventive arrangements disclosed above.

Further, a computer program product loadable into the internal memory of a computer of an animal handling arrangement is claimed, comprising software code portions for carrying out the inventive control method disclosed above when the computer program product is run on the computer.

It shall be appreciated that the grazing paddocks 12 may be of a much higher number, may be of different shapes, may be located in different patterns, or may be dispensed with. Further, the raceways 14a-c and the gate arrangements/selection boxes 21a-c may be located and designed differently or may be dispensed with. Still further, the process and control device of the invention may be a separate device from a centralized process and control device which is responsible for the overall control of the animal arrangement.

In another embodiment, the inventive arrangement and method are implemented in an indoor animal arrangement comprising a milking area with an automated rotary milking system, wherein animals may enter the milking area to be milked on a voluntary or semi-voluntary basis after having been identified.

In yet other embodiments the inventive arrangement and method are implemented in animal arrangements comprising a milking area with other kinds of milking systems, particularly automated milking systems, semi-automated milking systems, voluntary milking systems, semi-voluntary milking systems, milking systems wherein a plurality of animals are milked concurrently with one another, or any combinations thereof.

It shall further be appreciated that the various aspects and embodiments of the invention as disclosed above may be combined in a plurality of manners. The scope of protection of the present invention is only given by the following claims.

1-21. (canceled)

22. A method for control of milking of animals permitted to move in an area (11) intended therefore, said area including a milking area (13) that includes an automatic milking system (16) for milking animals that have moved to the milking area (13), the method comprising the steps of:
identifying (31) each of the animals that enter said milking area (13);
determining (32), for each of the identified animals, an expected milk yield obtainable from milking;
repeatedly determining (33) an accumulated expected milk yield obtainable from milking of the identified animals based on the expected milk yields determined for each of the identified animals; and
initiating (34) a milking session by the automatic milking system (16) for milking the animals that have entered the milking area (13) depending on the repeatedly determined accumulated expected milk yield.

23. The method of claim 22 wherein the expected milk yield determined for each of the identified animals is based on previously collected data associated with each animal.

24. The method of claim 24, wherein the previously collected data includes any of previous milk yields, previous milking times, and previous times lapsed between milkings.

25. The method of claim 22, wherein the identified animals that enter said milking area (13) are animals that have achieved permission to be milked.

26. The method of claim 22, wherein the milking session by the automatic milking system (16) is initiated when the accumulated expected milk yield exceeds a predetermined threshold value.

27. The method of claim 26, wherein the threshold value is based on revenues associated with the accumulated expected milk yield and costs for operating the automatic milking system (16).

28. The method of claim 27, wherein the threshold value is based also on a preparation time required by said milking system before the milking session commences.

29. The method of claim 27,
wherein an entry time is registered for each of the animals that enter said milking area (13), and
wherein the threshold value is also based on said entry times.

30. The method of claim 22, further comprising the step of:
offering the animals that enter said milking area (13) feed, water, and/or rest; and
subsequently, depending on the repeatedly determined accumulated expected milk yield, permitting the animals to enter the automatic milking system (16).

31. The method of claim 22, further comprising the step of:
providing an area that includes at least one grazing paddock (12) in which the animals can graze, said grazing paddock being located remote from the milking area (13), and a raceway (14a-c) via which the animals can move between the at least one grazing paddock (12) and the milking area (13).

32. The method of claim 31, further comprising the steps of:
identifying animals that are to access said milking area (13) via the raceway (14a-c) in at least one position located remote from the automatic milking system;
predicting a future amount of animals in the milking area (13) based on the animals identified in the at least one remote position,
wherein the milking session is also initiated by the automatic milking system (16) depending on the predicted future amount of animals in the milking area (11).

33. The method of claim 22, further comprising the step of:
configuring the automatic milking system to milk a plurality of animals concurrently with one another.

34. A computer program product loadable into the internal memory of a computer (17) of an animal handling arrangement, comprising software code portions for performing the method as claimed in claim 22 when said product is run on said computer.

35. An arrangement for control of milking of animals permitted to move in an area (11) intended therefore, said area including a milking area (13) that includes an automatic milking system (16) for milking animals that have moved to the milking area (13), the arrangement comprising:
one or more animal identification devices configured to identify each of the animals that enters said milking area; and
a process and control device (17) operatively connected to the one or more animal identification devices, the process and control device configured to:
determine, for each of the identified animals, an expected milk yield obtainable in milking;
repeatedly determine an accumulated expected milk yield obtainable in milking the identified animals based on the expected milk yields determined for each of the identified animals; and
initiate a milking session by the automatic milking system (16) for milking the animals that have entered the milking area (13) depending on the repeatedly determined accumulated expected milk yield.

36. The arrangement of 35,
wherein the process and control device is configured to initiate when the accumulated expected milk yield exceeds a predetermined threshold value, and
wherein said threshold value is based on revenues corresponding to the repeatedly determined accumulated expected milk yield and costs for operating the automatic milking system (16).

37. The arrangement of claim 35,
wherein at least one of the one or more animal identification devices are located remote from the automatic milking system and configured to identify animals that are to access said milking area (13) via a raceway (14a-c) that provides a path for animals to move from at least one grazing paddock (12) to said milking area (13),
wherein the process and control device is operatively connected to the at least one animal identification device located remote from the automatic milking system, and
wherein the process and control device is further configured to predict a future amount of animals in the milking area (13) based on the animals identified by the at least one animal identification device located remote from the automatic milking system, the initiation of the milking session by the automatic milking system also depending on the predicted future amount of animals in the milking area.

38. The arrangement of claim 35, wherein the milking session initiated by the process and control device (17) automatically milks a plurality of animals concurrently with one another.

39. An automated rotary milking system comprising the arrangement of claim 35.

40. The method of claim 32, further comprising:
predicting a future accumulated expected milk yield based on the predicted future amount of animals in the milking area (13) and on the expected milk yields determined for each of the identified animals.

41. The arrangement of claim 37, wherein the process and control device is further configured to predict a future accumulated expected milk yield based on the predicted future amount of animals in the milking area (13) and on the expected milk yields determined for each of the identified animals, the initiation of the milking session by the automatic milking system also depending on the predicted future accumulated expected milk yield.

42. The method according to claim 28, wherein the threshold value is based on an expected time for attaching teat cups to a first one of the identified animals to be milked.
